(19) United States
(12) Patent Application Publication
(10) Pub. No.: US 2025/0319643 A1
(43) Pub. Date: Oct. 16, 2025

(54) In-Mold Labeling Process for Attaching Planar Flexible Label to Curved Surface of Container

(71) Applicant: Technical Response, Inc., Knoxville, TN (US)

(72) Inventor: Leonard Scott Huff, Knoxville, TN (US)

(73) Assignee: Technical Response, Inc., Knoxville, TN (US)

(21) Appl. No.: 19/175,051

(22) Filed: Apr. 10, 2025

(30) Foreign Application Priority Data
Apr. 16, 2024 (CN) 202410452671.5

(51) Int. Cl. B29C 49/24

(52) U.S. Cl. CPC B29C 49/2408; B29C 2049/24302; B29C 2049/2437

(57) ABSTRACT

An in-mold labeling process attaches a planar flexible label to a three-dimensional curved surface of a container. The planar label is punched from a planar flexible base material according to a preset shape, which is a planar shape formed by unfolding the three-dimensional face of the container. During molding, air pressure keeps the planar label at a pre-labeling position and deforms the label along an inner wall of a cavity to maintain adhesion, so that the planar label is converted into a three-dimensional label. Based on the characteristics of the flexible material, the label deforms along the inner wall of the cavity while maintaining the outer contour of the label flush with the periphery of the pre-labeling position. The process allows the label and container to be integrally molded, ensuring the stability of adhesion and providing better wear resistance and protection.

### FIELD

The present disclosure relates to the field of in-mold labeling, and in particular, relates to an in-mold labeling process for attaching a planar flexible label to a surface of a container having a three-dimensional curved surface.

### BACKGROUND

The existing label attaching process cannot be effectively applied to an object of a container having a three-dimensional curved surface. In order to adapt a label to the three-dimensional curved surface of the object, traditional methods generally require the label to be made in a three-dimensional shape. This process not only involves high technical requirements, but also involves complicated technical processes with a plurality of steps such as 3D modeling, molding and clipping, which significantly increases the complexity and cost of production. Due to the complexity of the technical processes, the production efficiency is relatively low. Accurate operation and adjustment are required for each step, which not only consumes time, but also may lead to production bottlenecks, affecting the overall production efficiency. Moreover, when such a label is attached onto the object, it is difficult to ensure the stability of adhesion. Due to the irregularity of the curved surface, the label is prone to wrinkling and falling off, affecting the appearance and service life of a product and causing failure of performing an effective wear-resistant and protective function for the object.

What is needed, therefore, is an in-mold labeling process for attaching a planar flexible label to a surface of a container having a three-dimensional curved surface, to solve the existing problems in the aforementioned prior art.

### SUMMARY

The above and other needs are met by an in-mold labeling process for attaching a planar flexible label to a surface of a container having a three-dimensional curved surface, including following steps:
S1: punching out a flexible planar label from a planar base material made of a flexible material according to a preset shape, wherein the preset shape is a planar shape formed by unfolding the three-dimensional face of the container where the label is to be attached;
S2: placing the flexible planar label into a cavity of an extruding-blowing mold, wherein air pressure, during molding, causes the flexible planar label to be kept at a pre-labeling position and deform along with an inner wall of the cavity to maintain adhesion, so that the flexible planar label is converted into a flexible three-dimensional label, and an outer contour of the flexible three-dimensional label is kept flush with a periphery of the pre-labeling position after being attached; and
S3: integrally blow molding the flexible planar label and the container using the in-mold labeling process.

In some embodiments of the process, the flexible material is TPE, EVA, PU or a rubber material.

In some embodiments of the process, the thickness of the flexible planar label ranges from 0.1 mm to 3 mm.

In some embodiments of the process, a pattern layer is disposed on the flexible planar label.

In some embodiments, the process further includes printing a pattern to the pattern layer of the flexible planar label prior to step S2.

In some embodiments of the process, a 3D texture process or a digital printing process is used for printing the pattern.

In some embodiments of the process, a preset pattern region and a deformation region are disposed on the flexible three-dimensional label. After the flexible planar label is converted into the flexible three-dimensional label, the pattern on the pattern layer is located in the preset pattern region, and the preset pattern region obtains a preset pattern.

In some embodiments of the process, absorption holes are formed in the inner wall of the cavity at step S2, and under the action of air pressure during molding, the flexible planar label is kept at a pre-labeling position and deforms along with the inner wall of the cavity to maintain adhesion.

In some embodiments of the process, the container is barrel-shaped.

In some embodiments of the process, the planar base material is manufactured through extruding or mold pressing or injection molding at step S1.

Implementing embodiments of the present disclosure has the following beneficial effects:

1. The present disclosure uses a flexible material to manufacture a flexible planar label. Using the characteristics of the flexible material, the flexible planar label is converted into a flexible three-dimensional label during the process of conforming to the shape of the inner wall of the cavity, thereby reducing the impact on the edge, and ensuring that the outer contour of the flexible three-dimensional label is kept flush with the periphery of the pre-labeling position after being attached. By punching out the flexible planar label from the planar base material according to the preset shape, the label manufacturing process can be simplified, thereby significantly reducing the complexity and cost of production. Using the labeling method of the present disclosure, the flexible planar label and the container are integrally molded, ensuring the stability of adhesion, preventing the label from wrinkling and falling off, and providing a better wear-resistant and protective function.

2. A pattern layer is disposed on the flexible planar label, which performs a better decorative function while having a better wear-resistant and protective function on the container, thereby improving the experience of a user. The 3D texture process can create a three-dimensional visual effect on the pattern, making the pattern more vivid. The 3D texture process not only improves visual effect, but also adds haptic feelings, providing the user with a richer experience. With the digital printing process, special inks and processing techniques can be used to improve the durability and color fading resistance of the pattern, ensuring the pattern to be bright-colored and clear for a long term. The digital printing process can be applicable to various materials and surfaces, including complicated three-dimensional curved surfaces.

3. After being attached, the flexible planar label is converted into the flexible three-dimensional label. The preset pattern region and the deformation region are disposed on the flexible three-dimensional label. The preset pattern is obtained on the preset pattern region and the pattern on the flexible planar label is different from that on the preset pattern. The cooperation between the preset pattern region and the deformation region can prevent the preset pattern from deforming or distorting, making the label attractive and practical.

### BRIEF DESCRIPTION OF THE DRAWINGS

In order to describe the technical solutions in embodiments of the present disclosure more clearly, the following will briefly introduce the accompanying drawings needed in the description of the embodiments. Obviously, the accompanying drawings described below depict merely some embodiments of the present disclosure. An ordinary person skilled in the art can obtain other drawings from these accompanying drawings without making creative efforts.

FIG. 1 depicts a flexible three-dimensional label and a container formed by an in-mold labeling process according to an embodiment of the disclosure;

FIG. 2 depicts an exploded diagram of a flexible three-dimensional label and a container formed by an in-mold labeling process according to an embodiment of the disclosure; and

FIG. 3 depicts a planar base material and a flexible planar label according to an embodiment of the disclosure.

FIG. 4 depicts steps of an in-mold labeling process for attaching a planar flexible label to a surface of a container having a three-dimensional curved surface according to an embodiment of the disclosure.

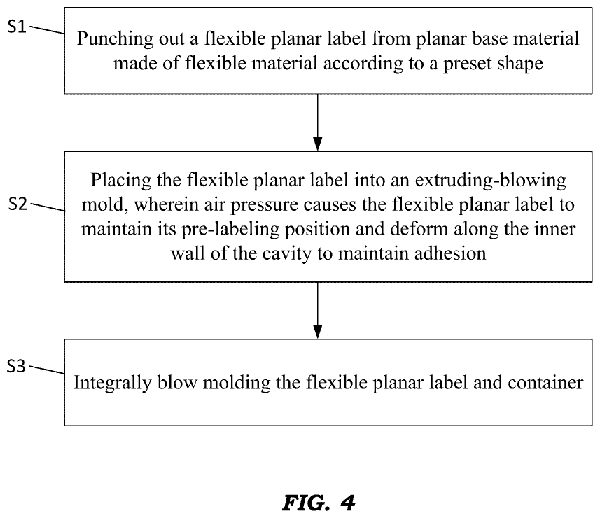

### DETAILED DESCRIPTION

The technical solutions in embodiments of the present disclosure will be clearly and completely described below in conjunction with accompanying drawings. Obviously, the described embodiments are merely some embodiments in the present disclosure, rather than all embodiments. All other embodiments obtained by an ordinary person skilled in the art without making creative efforts shall fall within the protection scope of the present disclosure.

Embodiments of the present disclosure provide an in-mold labeling process for attaching a planar flexible label to a surface of a container having a three-dimensional curved surface. The process includes following steps:
S1: punching out a flexible planar label 10 from a planar base material 1 made of a flexible material according to a preset shape, wherein the preset shape is a planar shape formed by unfolding the three-dimensional face of the container 2 where the label is to be attached;
S2: placing the flexible planar label 10 into a cavity of an extruding-blowing mold, wherein air pressure, during molding, causes the flexible planar label 10 to be kept at a pre-labeling position and to deform along with an inner wall of the cavity to maintain adhesion, so that the flexible planar label 10 is converted into a flexible three-dimensional label 100, and an outer contour of the flexible three-dimensional label 100 is kept flush with a periphery of the pre-labeling position after being attached; and
S3: integrally blow molding the flexible planar label 10 and the container 2 according to the in-mold labeling process.

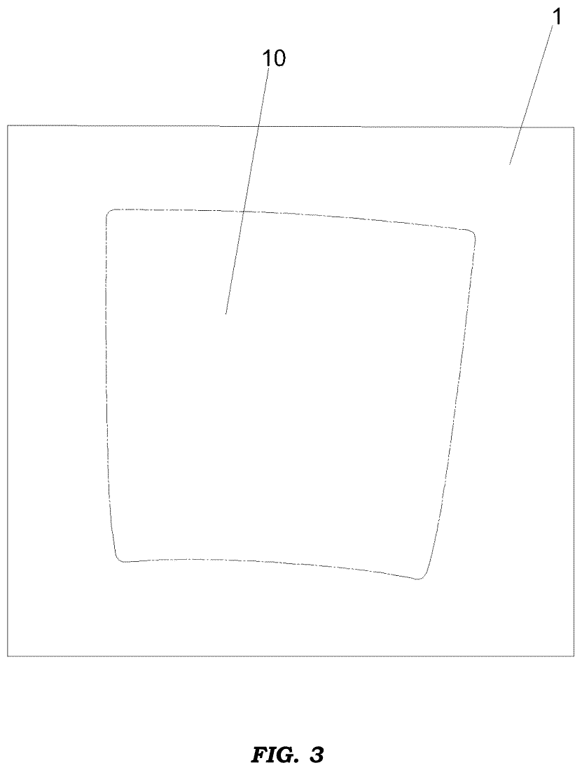

Specifically, as shown in FIG. 3, the flexible material 1 has sufficient flexibility and plasticity so as to adapt to the curved shape of the container without cracking or deforming in subsequent steps. At step S1, computer-aided design CAD software is preferably used for designing the preset shape of the flexible planar label 10 according to the planar shape formed by unfolding the three-dimensional face of the container 2. This can be a combination of a planar pattern or a pattern and for the shape thereof, and the deformation and stretching of the label when attached to the surface of the container 2 should be considered. For the operation of punching the label, equipment such as a CNC punch press or die are preferably used. According to the designed preset shape, the punching operation is performed on the planar base material 1 to cut the planar base material 1 into the flexible planar label 10 at a corresponding shape. By ensuring punching accuracy and precision, the adhesion of the label to the surface of the container is ensured.

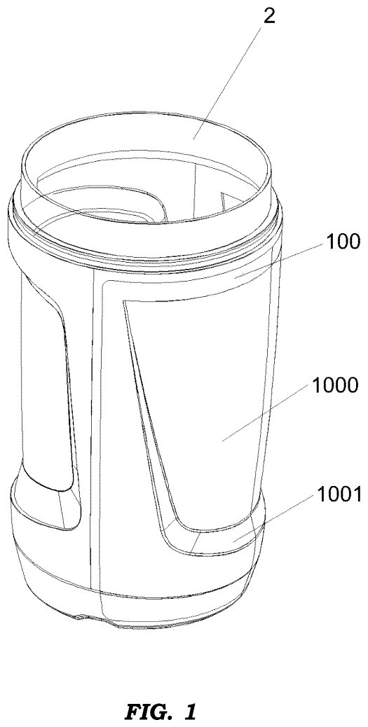

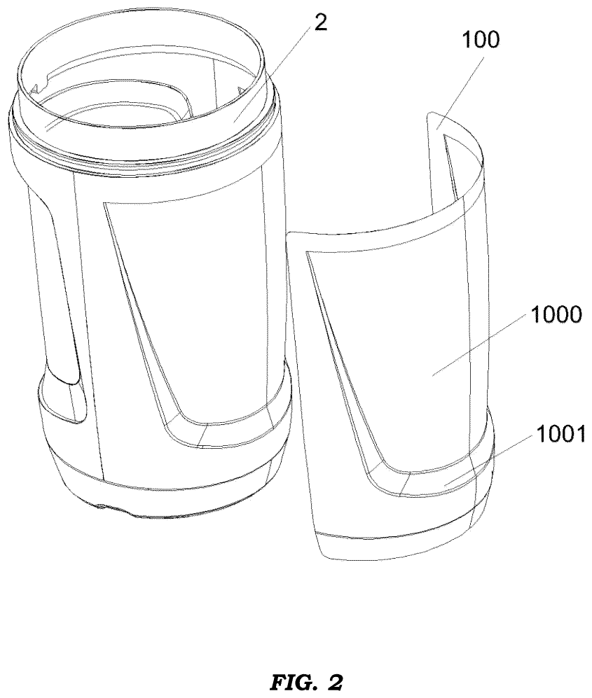

At step S2, when placing the flexible planar label 10 into the cavity of the extruding-blowing mold, a positioning clamp or a positioning structure in the mold can be used to ensure the alignment of the label with the pre-labeling position. The shape of the inner wall of the cavity is matched with the outline of the container 2. Referring to FIG. 2, the mold has sufficient heat resistance and wear resistance to endure high temperature and pressure during the blow molding process. The pre-labeling position refers to a position on a three-dimensional curved surface of the container 2 where the flexible planar label 10 is to be attached. The position is predetermined, can be calculated or measured in advance, and determined on the planar shape of the container after being unfolded and marked out during the production process, so as to accurately attach the flexible planar label 10 to the corresponding position on the surface of the container 2. After being attached, the flexible planar label 10 is converted into the flexible three-dimensional label 100, and the shape of the flexible three-dimensional label 100 is fit with the three-dimensional curved surface of the container 2, and the attached position corresponds accordingly, as shown in FIG. 1 and FIG. 2. Regarding step S3, during the blow molding portion of the in-mold labeling process, the pressure and temperature in the extruding-blowing mold are controlled to ensure that the flexible planar label can be fully attached to the inner wall of the cavity, and flush with the periphery of the pre-labeling position. Appropriate pressure and temperature will cause the flexible planar label to deform and be attached to the inner wall of the cavity better and converted into the flexible three-dimensional label 100. In this manner, the final technical effects of the present disclosure are achieved, as depicted in FIG. 1.

A preferred embodiment of the present disclosure uses the flexible material to manufacture the flexible planar label. Using the characteristics of the flexible material, the flexible planar label is converted into the flexible three-dimensional label during the process of conforming to the shape of the inner wall of the cavity. This reduces the impact on the edge, ensuring that the outer contour of the flexible three-dimensional label is kept flush with the periphery of the pre-labeling position after being attached. By punching out the flexible planar label from the planar base material according to the preset shape, the label manufacturing process can be simplified, thereby significantly reducing the complexity and cost of production. Using the labeling method of the present disclosure, the flexible planar label and the container are integrally molded to ensure the stability of adhesion, thereby preventing the label from wrinkling and falling off, and providing a better wear-resistant and protective function.

Furthermore, the flexible material is TPE, EVA, PU or a rubber material in preferred embodiments. Specifically, TPE (thermoplastic elastomer), EVA (ethylene vinyl acetate), PU (polyurethane), and rubber material all have favorable softness and plasticity, and can keep the shape stable and ensure good attachment upon being attached to the curved surface of the container. According to the preset shape, the flexible planar label is designed and precisely punched out using CAD software. Considering the characteristics of TPE, EVA, PU and rubber material, the flexible label has sufficient flexibility and plasticity, which can adapt to complicated curved shapes of the container. The label attachment method using TPE, EVA, PU, rubber and other flexible materials can be effectively applied to a container having a three-dimensional curved surface and achieve a high-quality attachment effect.

Furthermore, the thickness of the flexible planar label 10 ranges from 0.1 mm to 3 mm. Specifically, an appropriate thickness can be selected according to different product specifications and use scenarios. Formulations and production processes of the materials can be adjusted for labels of different thicknesses to ensure that the labels have required softness and strength. Optionally, a flexible material with higher softness can be selected for the flexible planar label 10 with a thickness ranging from 0.1 mm, and the flowability and hardness of the material can be appropriately adjusted to ensure the adhesion and stability of the label. Regarding selection of a material with higher softness, TPE (thermoplastic elastomer) is preferably selected. TPE is a thermoplastic material with high plasticity, which can be processed through heating and plastic molding to produce various shapes, thereby being applicable to complicated curved surfaces of the container. To accommodate labels of different thicknesses, adjustments can be made to the temperature, pressure, blow molding speed, and other parameters in the extruding-blowing mold during the blow molding process to ensure that the label can be fully attached to the inner wall of the cavity and be flush with the periphery of the pre-labeling position. Depending on the thickness of the labels, the blow molding parameters may need to be adjusted for labels at different thicknesses to achieve the optimal attachment effects and molding quality.

Furthermore, a pattern layer is disposed on the flexible planar label 10. Specifically, as shown in FIG. 3, the pattern layer can perform a decorative function, providing a better experience for a consumer.

Furthermore, step S1 of the process may further include printing a pattern onto the pattern layer of the flexible planar label 10 prior to step S3. Printing the pattern on the pattern layer of the flexible planar label can add decorative and visual attractions for the container, ensure the quality and durability of the pattern, and perform a decorative function, thereby enhancing the consumer experience.

Furthermore, a 3D texture process or a digital printing process may be used at step S2 for printing the pattern. Specifically, the 3D texture process can create a three-dimensional visual effect on the pattern, making the pattern more vivid. The 3D texture process not only improves the visual effect, but also adds haptic feelings, providing the user with richer experience. With the digital printing process, special inks and processing techniques can be used to improve the durability and color fading resistance of the pattern, ensuring the pattern is bright-colored and clear for a long term. The digital printing process can be applicable to various materials and surfaces, including complicated three-dimensional curved surfaces.

Furthermore, a preset pattern region 1000 and a deformation region 1001 are disposed on the flexible three-dimensional label 100. After the flexible planar label 10 is converted into the flexible three-dimensional label 100, a pattern on the pattern layer is located in the preset pattern region 1000, and the preset pattern region 1000 obtains a preset pattern. Specifically, as shown in FIG. 1 and FIG. 2, after the flexible planar label 10 is converted into the flexible three-dimensional label 100, the pattern layer of the flexible planar label 10 is also converted into the preset pattern region 1000 and the deformation region 1001. After attachment, the preset pattern region will obtain a preset pattern. It should be noted that the pattern on the pattern layer is different from that on the preset pattern. The purpose of the deformation region 1001 is to prevent the preset pattern from being deformed or distorted during the process of converting the flexible planar label 10 into the flexible three-dimensional label 100, making the label attractive and practical.

Furthermore, at step S2, suction holes are provided in the inner wall of the cavity, and under the action of air pressure during molding, the flexible planar label 10 is kept at a pre-labeling position and deforms along with the inner wall of the cavity to maintain adhesion. Specifically, during the mold design, a micro vacuum hole is preferably selected as the suction holes. Such holes can produce suction forces through a vacuum pump system, thereby adhering the flexible planar label to a correct position. Such a design can improve the positioning accuracy and stability of the label in the molding process. The air pressure during molding can be accurately controlled, and in combination with the function of the suction holes, the flexible planar label can deform along with the inner wall of the cavity to maintain adhesion. The sizes, shapes and distribution of the suction holes in the inner wall of the cavity can be optimized according to the size and shape of the label, as well as features of the three-dimensional curved surface of the container, thereby ensuring that the label can be smoothly attached to the inner wall of the cavity at all positions.

Furthermore, in some embodiments the container 2 is barrel-shaped, as shown in FIG. 1 and FIG. 2. Based on the planar shape formed by unfolding the three-dimensional face, the preset shape of the flexible planar label 10 is designed to realize attachment and deformation of the flexible planar label 10 when being placed in the cavity of the extruding-blowing mold. The container 2 is preferably an insulation barrel. It should be understood that a material with good softness such as TPE and EVA is selected to enable that the flexible planar label 10 can also enhance the sealing and softness of the insulation barrel, thus improving the insulation effect, reducing heat loss and enhancing the insulation efficiency. The flexible planar label is made of PE, EVA and other flexible materials, which is easy to clean and facilitates the cleaning of the surface of the insulation barrel to maintain hygiene and attractiveness. More preferably, the flexible material generally has a good water resistance, and the waterproof and moisture-proof performance of the insulation barrel can be enhanced when the flexible material is applied to the manufacturing of the insulation barrel.

Furthermore, at step S1, the planar base material 1 is manufactured through an extruding or molding pressing or injection molding manner. Specifically, regarding the extruding method, firstly, the selected material is heated to an appropriate temperature and then is injected into an extruder, and the molten material is extruded through screws of the extruder into continuous blanks of the desired shape. For the mold pressing or injection molding method, it is similarly required to heat the material to an appropriate temperature and then inject it into the mold or the injection-molding machine. Through application of pressure or injection speed, the molten material is filled into the mold to form the planar base material 1 into the desired shape.

The present disclosure uses the flexible material to manufacture the flexible planar label. Using the characteristics of the flexible material, the flexible planar label is converted into the flexible three-dimensional label during the process of conforming to the shape of the inner wall of the cavity, thereby reducing the impact on the edge and ensuring that the outer contour of the flexible three-dimensional label is kept flush with the periphery of the pre-labeling position after being attached. By punching out the flexible planar label from the planar base material according to the preset shape, the label manufacturing process can be simplified, thereby significantly reducing the complexity and cost of production. Using the labeling method of the present disclosure, the flexible planar label and the container are integrally molded to ensure the stability of adhesion, thereby preventing the label from wrinkling and falling off, and providing a better wear-resistant and protective function.

It should be understood that in the present disclosure, the terms “first”, “second” and the like are used to describe various information. However, such information should not be limited to these terms, as these terms are merely used to distinguish different types of information from each other. For example, without departing from the scope of the present disclosure, the “first” information can also be referred to as the “second” information. Similarly, the “second” information can also be referred to as the “first” information. Moreover, direction or position relationships indicated by such terms as “center”, “up”, “down”, “left”, “right”, “vertical”, “horizontal”, “inner” and “outer” are based on direction or position relationships indicated by accompanying drawings, and are merely intended to facilitate the description of the present disclosure and simplify the description, rather than indicate or imply that the indicated apparatus or element must have a particular direction and construct and operate at a particular direction. Therefore, it should not be understood as a limitation of the present disclosure.

Described herein are preferred embodiments of the present disclosure. It should be noted that an ordinary person skilled in the art can also make certain improvements and variations under the precondition of not departing from the principles of the present disclosure. Such improvements and variations are also regarded as within the protection scope of the present disclosure.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An in-mold labeling process for attaching a planar flexible label to a surface of a container having a three-dimensional curved surface, comprising the following steps:
punching out a flexible planar label from a planar base material made of a flexible material according to a preset shape, wherein the preset shape is a planar shape formed by unfolding the three-dimensional face of a container where the label is to be attached;
placing the flexible planar label into a cavity of an extruding-blowing mold, wherein air pressure, during molding, causes the flexible planar label to be kept at a pre-labeling position and deform along with an inner wall of the cavity to maintain adhesion, so that the flexible planar label is converted into a flexible three-dimensional label, and an outer contour of the flexible three-dimensional label is kept flush with a periphery of the pre-labeling position after being attached; and
integrally blow molding the flexible planar label and the container using the in-mold labeling process.

2. The process of claim 1, wherein the flexible material is any one of TPE, EVA, PU, or rubber.

3. The process of claim 2, wherein a thickness of the flexible planar label ranges from 0.1 mm to 3 mm.

4. The process of claim 3, wherein a pattern layer is disposed on the flexible planar label.

5. The process of claim 4, further comprising printing a pattern onto the pattern layer of the flexible planar label prior to placing the flexible planar label into the cavity of the extruding-blowing mold.

6. The process of claim 5, wherein a three-dimensional texture process or a digital printing process is used for printing the pattern.

7. The process of claim 6, wherein a preset pattern region and a deformation region are disposed on the flexible three-dimensional label, and after the flexible planar label is converted into the flexible three-dimensional label, the pattern on the pattern layer is located in the preset pattern region, and the preset pattern region obtains a preset pattern.

8. The process of claim 1, wherein suction holes are provided in the inner wall of the cavity, and under the action of air pressure during molding, the flexible planar label is kept at a pre-labeling position and deforms along with the inner wall of the cavity to maintain adhesion.

9. The process of claim 1, wherein the container is barrel-shaped.

10. The process of claim 1, wherein the planar base material is manufactured by extruding, mold pressing, or injection molding.
